(19) United States
(12) Patent Application Publication
(10) Pub. No.: US 2002/0191225 A1
(43) Pub. Date: Dec. 19, 2002

(54) Methods and arrangements for compressing raster data

(76) Inventor: Gary G. Stringham, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/874,728

(22) Filed: Jun. 4, 2001

(51) Int. Cl. H04N 1/41

(52) U.S. Cl. 358/426.13

(57) ABSTRACT

An apparatus is provided that includes data compression logic that is configured to receive a data stream and selectively count consecutive alike n-bit long words of data therein. Then, for each grouping of consecutive alike n-bit long words, the logic substitutes a control word that identifies the value of the alike n-bit long words and the counted number of alike n-bit long words within the grouping. Hence, the number of repeated same valued words can be significantly reduced. In certain implementations, the data stream is associated with a scanned image and the alike n-bit long words are selected from a grouping of image pattern values associated with white regions, black regions, and repeating pattern regions on the scanned page. This application of the invention significantly reduces the amount of data that needs to be buffered, for example, in a printer. The compression can occur at other locations too, like an external scanner and/or computer, thereby reducing the amount of data that needs to be transferred to a printer or like device.

### TECHNICAL FIELD

This invention relates to computers, printers and like devices, and more particularly to unique raster data compression methods and arrangements.

### BACKGROUND

Data compression schemes are often employed in devices to reduce the amount of data that needs to be stored and/or communicated. Several types of data compression are available for use, each having its own pros and cons. When selecting an appropriate data compression scheme, one typically looks at the expected efficiency and complexity of the underlying data compression algorithm(s). Here, for example, an efficient algorithm may be rejected because it proves to be too complex (e.g., time-consuming, computationally complex). Conversely, simple algorithms may prove to be inefficient. Consequently, certain devices lend themselves to certain data compression solutions.

One such system or device is a multifunction printer. A multifunction printer typically provides the capability to print documents and scan documents. Certain multifunction printers also include a facsimile capability. Thus, depending upon the type of multifunction printer, a document may be printed based on externally provided image information (e.g., from a computer, from a facsimile), or using image information (raster data) from a scanner. The latter, i.e., printing based on scanned image information, is akin to copying the scanned document.

Taking a closer look at these printing/copying capabilities, it quickly becomes apparent that an appreciable amount of image information is required. By way of example, assume that the device is configured to copy thirty-two pages per minute (PPM). For a twelve hundred dots per inch (DPI) resolution, this thirty-two PPM requirement would require the handling of about sixty-four megabits per second (64 Mbits/sec) of image information.

Current cost-efficient hardware and software that implement run-length compression algorithms and the like, are unable to adequately support such data rates. Of course, higher speed and specialized hardware can be developed to handle such data rates; however, doing so could be cost prohibitive. Consequently, there is a need for improved raster data compression methods and arrangements. Preferably, the improved methods and arrangements will be implementable in a cost-efficient manner.

### SUMMARY

In accordance with certain aspects of the present invention, improved raster data compression methods and arrangements are provided. The improved methods and arrangements can be implemented through cost-efficient hardware and/or software. The methods and arrangements include an improved raster data compression algorithm.

The above stated needs and others are met, for example, by an apparatus that includes data compression logic that is configured to receive a data stream and selectively count consecutive alike n-bit long words of data therein. Then, for each grouping of consecutive alike n-bit long words, the logic substitutes a control word that identifies the value of the alike n-bit long words and the counted number of alike n-bit long words within the grouping. Hence, the number of repeated same valued words can be significantly reduced.

In certain implementations, the data stream is associated with a scanned image and the alike n-bit long words are selected from a grouping of image pattern values associated with white regions, black regions, and repeating pattern regions on the scanned page. This application of the invention significantly reduces the amount of data that needs to be buffered, for example, in the printer. The compression can occur at other locations too, like an external scanner and/or computer, thereby reducing the amount of data that needs to be transferred to a printer or like device.

### BRIEF DESCRIPTION OF THE DRAWINGS

A more complete understanding of the various methods and arrangements of the present invention may be had by reference to the following detailed description when taken in conjunction with the accompanying drawings wherein:

FIG. 1 is a block diagram depicting an exemplary system having a multifunction printer that is connected to a network configured to support a variety of resources.

FIG. 2 is a block diagram depicting an exemplary multifunction printer as in FIG. 1, for example, having a data compressor and a data decompressor.

FIG. 3 is a block diagram depicting an exemplary data compressor as in FIG. 2, for example.

FIG. 4 is a block diagram depicting an exemplary data decompressor as in FIG. 2, for example.

FIG. 5 is a block diagram depicting an exemplary system having two devices configured to communicate information using a data compressor and/or data decompressor, as in FIGS. 3 and 4, respectively.

FIGS. 6 and 7 are block diagrams illustrating certain process steps associated with an exemplary compression algorithm and decompression algorithm, respectively.

FIGS. 8 and 9 are illustrative diagrams depicting a data stream during certain stages of compression/encoding.

### DETAILED DESCRIPTION

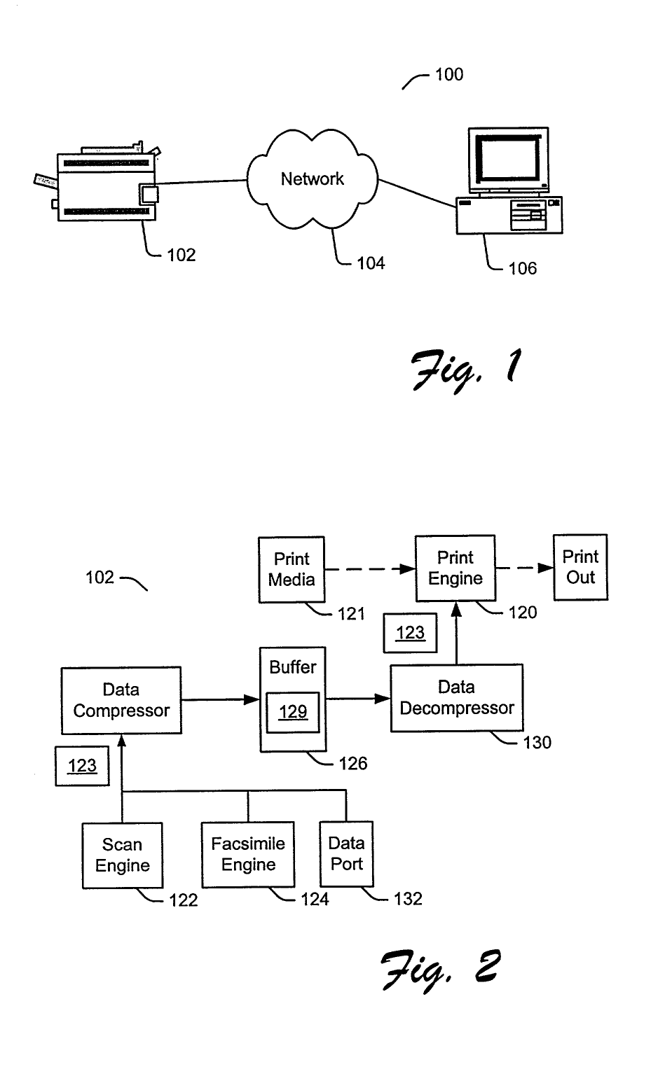

Reference is now made to FIG. 1, which is a block diagram depicting an exemplary system 100 having a multifunction printer 102. Printer 102 is operatively coupled to a network 104 that is configured to support a variety of resources. For example, a computer 106 is shown as being operatively coupled to network 104 and configured to send data to be printed to printer 102. Here, the data can be character data, such as, ASCII data, or the like. Additionally, the data from computer 106 can include image data (raster data). Of particular interest herein, is image data of alphanumeric characters, diagrams, photos, etc. Hence, computer 102 may provide a scanned image of text, for example, to printer 102 via network 104.

Multifunction printer 102 is depicted in greater detail in the block diagram of FIG. 2. Here, as shown, exemplary printer 102 includes a print engine 120, a scan engine 122, a facsimile engine 124, a buffer 126, a data compressor 128, a data decompressor 130, and a data port 132.

Print engine 120 is configured to affix an image to a media 121, such as, e.g., paper, plastic, fabric, etc. As is well known, the print engine may include a laser printing mechanism, ink jet mechanism, or the like to selectively transfer dry and/or liquid ink to the targeted print media 121. The image may include one or more colors.

Scan engine 122 is configured to scan or otherwise copy an image from a source object (not shown). Scan engine 122 generates a corresponding image data 123. Image data 123 may also be provided by computer 102, as described above, through data port 132. Facsimile engine 124 (which is optional) is configured to send/receive facsimile data. It is possible that the facsimile engine could also provide image data 123.

Data compressor 128 is operatively coupled to selectively compress all of, or at least a portion of image data 123 and store a corresponding compressed image data 129 in buffer 126. Here, image data 123 is compressed according to certain exemplary data compression techniques as described below. Data decompressor 130 is operatively configured to decompress compressed image data 129 thereby reproducing image data 123.

Here, the compression techniques were developed to allow printer 102 to support the handling of uncompressed 1200 DPI raster data at rates as high as about thirty-two PPM or approximately 64 MBits/sec. The compression techniques are substantially lossless, and may be implemented using mostly lower-speed hardware and/or software. Those skilled in the art will recognize that current monochrome printers require nearly 2 Mbytes of RAM and other high-speed hardware resources to support such data rates. Moreover, conventional run-length encoded data compression techniques would require the attendant high-speed hardware to work on the data bit-by-bit.

The compression and decompression techniques taught herein avoid the need for expensive high-speed circuitry.

Reference is now made to FIG. 3, which is a block diagram depicting an exemplary data compressor 128. Here, as shown, the incoming image data 123 is provided serially to a serial-to-parallel converter 200. Converter 200 utilizes an n-bit register (or the like) to convert n-bits of consecutively received image data 123 into an n-bit parallel word. While n can be any integer greater than two, in certain preferred implementations, however, n equals thirty-two. This allows for the incoming data rate of image data 123 to be reduced accordingly within data compressor 128 as the incoming serial data is stored in n-bit register 202, for example. The output from converter 200 is an n-bit word stored in register 202.

Next, an n-bit word 201 is provided to compressor block 204. Compressor block 204 selectively compresses the n-bit words according to the data compression or encoding algorithm as described below and stores the resulting compressed image data 129 in buffer 126.

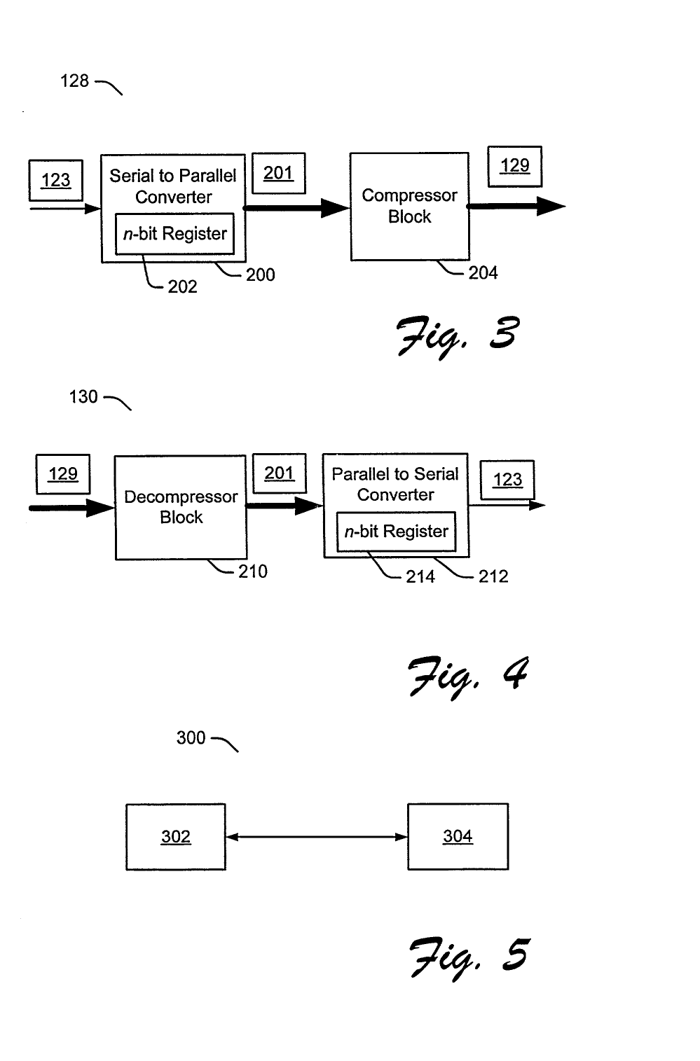

With this in mind, data decompressor 130 operates essentially in reverse of data compressor 128. Thus, for example, as depicted in FIG. 4, data decompressor 130 includes a decompressor block 210 that is configured to selectively access compressed image data 129 and apply the data decompression algorithm as described below to reproduce corresponding n-bit words 201. These n-bit words 201 are then reconverted into serial image data 123 by a parallel-to-serial converter 212 having an n-bit register 214. The output of parallel-to-serial converter 212 is then provided to print engine 120.

Before describing certain exemplary data compression and decompression algorithms that can be employed in the above arrangements, attention is drawn to other arrangements that may make use of such compression/decompression capabilities. The compression algorithm, for example, takes advantage of the fact that there are often significant amounts of white space on a printed page, especially around the border of the text/page and in between the lines of text. Large stretches of black or patterned areas may also exist, such as, an underline, a borderline, etc. The compression algorithm is configured to detect such areas within image data 123 in an n-bit word by n-bit word manner, and to selectively encode singular n-bit word and plural, consecutive n-bit words into compressed image data 129. Consequently, the various methods and arrangements provided herein may be applied to any serial data stream having patterns within the data that can be detected and encoded.

Thus, reference is drawn to FIG. 5, which is a block diagram depicting an exemplary system 300 having two devices, 302 and 304, configured to communicate information using a data compressor and/or data decompressor, as in FIGS. 3 and 4, respectively. Devices 302 and 304 may include computers, data communication devices, scanners, facsimiles, projectors, mobile communication devices, handheld devices, personal digital assistants (PDAs), and other like devices.

The following sections describe exemplary data compression and data decompression schemes or algorithms that may be implemented as described above.

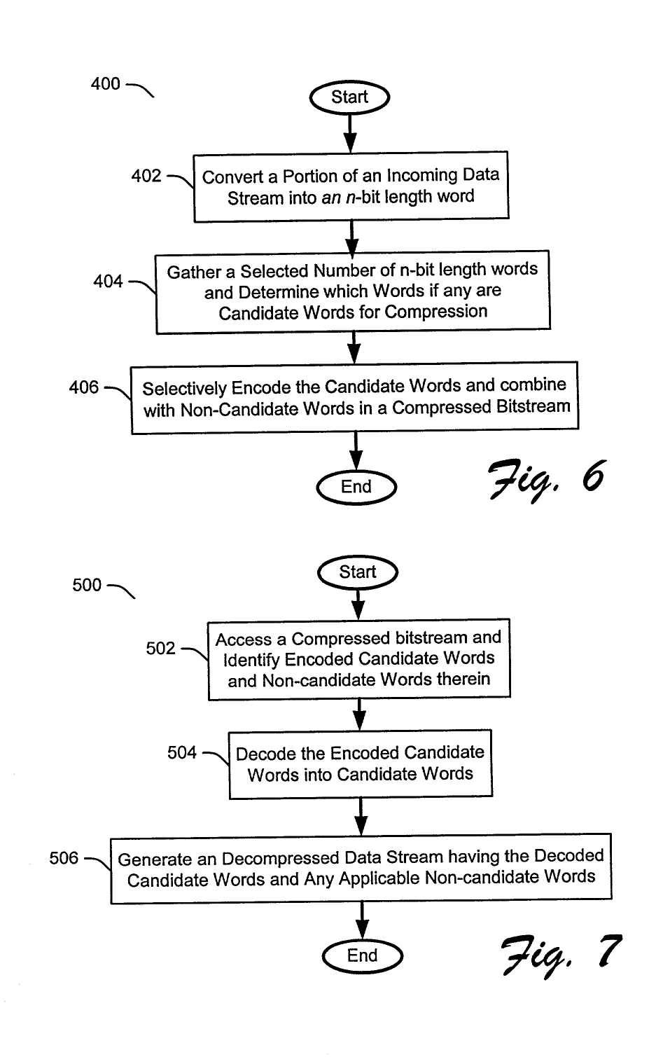

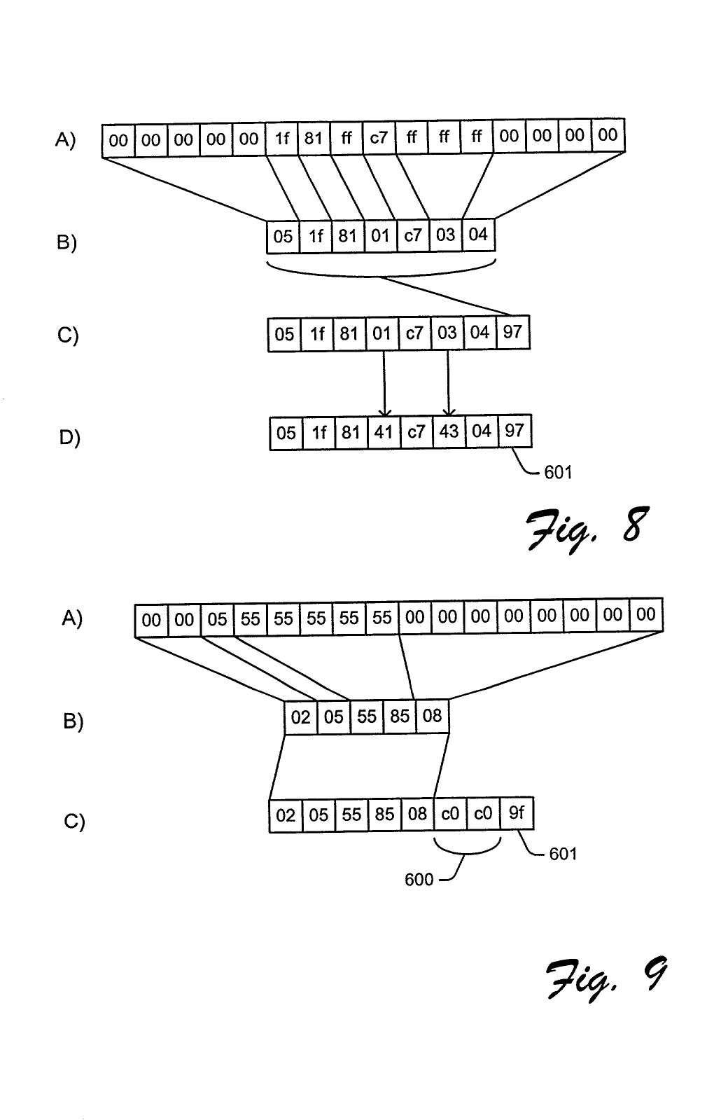

FIGS. 6 and 7 are block diagrams illustrating certain process steps associated with an exemplary compression algorithm and decompression algorithm, respectively.

A compression process 400 is illustrated in FIG. 6. In step 402 a portion of an incoming data image or bitstream is converted or otherwise partitioned into an n-bit length word. Here, for example, the first 32 bits of data may be converted into a first word.

Next, in step 404, a number (i.e., k number) of consecutively n-bit words of the incoming data stream are gathered as a determination is made as to which, if any, of the words are candidate words for compression. A candidate word for compression may include any defined (predefined or learned) n-bit word pattern. For example, scanned textual images usually include several consecutive white valued words corresponding to the white areas on a scanned image. Additionally, there may be groupings of black valued words corresponding to black areas. Each of these word values may be used to determine if a word is a candidate word for encoding. Other candidate words in step 404, may include predefined or learned repeating patterns/values. In this manner, in step 404, each of the gathered words is determined to be either a candidate word for compressing (of which there may be a plurality of types) or a non-candidate word.

In step 406, the candidate words, if any, are selectively encoded and combined with any remaining non-candidate words to produce a compressed bitstream. The encoding process includes adding control words to the compressed bitstream. These control words are specifically encoded to identify associated encoded candidate words, non-candidate words and/or other control words within the bitstream. Each type of candidate word will have an associated control word that is configured to identify the candidate word bit value and number of consecutive words thereof. An example of this is presented in the sections that follow. Certain control words are used to differentiate between non-candidate words and control words. Furthermore, in certain instances control words are inserted into the compressed bitstream as fill or dummy words and have no further use.

In FIG. 7, a process 500 is shown for decompressing or decoding a compressed bitstream resulting from process 400. In step 502, the compressed bitstream is accessed or otherwise provided. Any encoded candidate words and non-candidate words are determined by examining a particular control word(s) within a certain sized portion of the compressed bitstream. Non-candidate words need not be decoded, however, candidate words need to be decoded. This is accomplished in step 504, wherein the appropriate numbers of candidate words are regenerated according to their respective control words. Then, in step 506 the decoded candidate words are appropriately arranged, with respect to any non-candidate words, to generate a decompressed bitstream.

An exemplary populated data stream associated with a scanned text image will now be described as a result of the above methods and arrangements.

This exemplary algorithm shifts all the incoming bits into a 32-bit register 202, allowing for slower hardware speeds. Compression block 204 then uses that 32-bit word to generate a compressed 32-bit word stream. Since most of the text image is white, most of the 32-bit words will be 0×00000000. Thus, let white words be a type of candidate word for compression. As such, the algorithm counts up the number of consecutive white words (0×00000000). Further, let black words also be defined as candidate words for compression. Thus, the number of consecutive black words (O×FFFFFFFF) is also counted. Mixed words (containing both l's and O's) will simply be passed through in this example, as non-candidate words.

Reference is first made to FIG. 8, which shows an example of an incoming bit stream at various stages of processing. For the purposes of the examples used herein, the bitstream is illustrated in hex values using 8-bit words.

As depicted in stage A of FIG. 8, the initial bitstream is “00 00 00 00 00 1f 81 ff c7 ff ff ff 00 00 00 00”. At stage B the bitstream has been reduced in size by identifying candidate words (white and black words). Close inspection shows that there were, in order, “05” number of consecutive white words, non-candidate words of values “1f” and “81”, one candidate black word “01”, one non-candidate word “c7”, “03” number of consecutive black words, and “04” number of consecutive white words. As shown here, the counted number of consecutive candidate words (e.g., “04”, “05”, etc.) is actually a control word, while the non-candidate word continues to remain a data word.

In order for decompressor 130 to distinguish between a counted number of white words or black words (i.e., control words) from a non-candidate word (i.e., a data word), another control word is provided.

Thus, in this example, for every 7 words, another control word is added wherein each of its 7 bits is used to indicate whether the previous 7 words are control words (indicated by a binary 1) or data words (indicated by a binary 0). The 7 words plus the indicator word makes an 8-word packet. This is shown at stage C in FIG. 8, wherein the “97” is an indicator control word 601 that so identifies the previous 7 words as being either control words or data words.

With respect to the control words, there is still a need to distinguish whether a count is for consecutive white words or consecutive black words. In this example (stage D), the two most significant bits in the counting control words have been used (leaving the rest of the bits for the count). Thus, for 4 example, if the two most significant bits are OOb, the count is for white-words. If the two most significant bits are Olb, the count is for black-words.

Another area for compression is repeating patterns, such as those that would appear in an area of dither patterns or hash lines. In other words, the same non-candidate word appears several times in a row. Here, as previously mentioned, these words can be pre-defined as being candidate words or can be recognized and learned. Another control word can be created to indicate a count of the number of consecutive patterned words. The pattern that repeated would be the previous mixed control word in the resulting compressed data stream. An example is depicted in FIG. 9.

In FIG. 9, an example bit stream (stage A) with patterned words and its resulting compressed data stream (stage C). To indicate a mixed control word, the two most significant bits will be lOb. As shown in FIG. 9, at stage A, the bitstream is “00 00 05 55 55 55 55 55 00 00 00 00 00 00 00 00”. At stage B in the process, it is determined that there are “02” number of consecutive white words, a “05” mixed word, a “55” mixed word (here a candidate word identifying the data) followed by an associated “85” number of consecutive mixed words, and then “08” number of consecutive white words. The “85” control word is configured to identify the count and the fact that the count is associated with the previous mixed value word with 11b in the two most significant bits.

Notice that the resulting compressed stream only yielded five words. To make proper use of the indicator control word 601 dummy words 600 are added in stage C.

Although some preferred implementations of the various methods and arrangements of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims. For example, the methods and arrangements are easily adapted for color printing, wherein another color value could take the place of the black color value.

What is claimed is:

1. An apparatus comprising:
data compressor logic operatively configured to receive a data stream and selectively count consecutive alike n-bit long words therein and, for each grouping of consecutive alike n-bit long words, substitute a control word that identifies a value of the alike n-bit long words and a counted number of alike n-bit long words within the grouping.

2. The apparatus as recited in claim 1, wherein the data stream is associated with a scanned image and the alike n-bit long words are selected from a grouping of image pattern values associated with white regions, black regions, and repeating pattern regions.

3. The apparatus as recited in claim 1, further comprising a buffer operatively coupled to the data compressor logic and wherein the data compressor logic is further configured to output a compressed data stream comprising at least one control word to the buffer.

4. The apparatus as recited in claim 3, wherein the data compressor logic is further configured to provide at least one identifier control word in the compressed data stream that specifically identifies data words and control words therein.

5. The apparatus as recited in claim 4, further comprising data decompressor logic operatively coupled to the buffer and configured to access the compress data stream and, using the data words and control words therein, regenerate the data stream.

6. The apparatus as recited in claim 5, further comprising a print engine that is operatively coupled to receive the output of the data decompressor logic and in response generate a corresponding print out.

7. The apparatus as recited in claim 5, further comprising a scan engine that is operatively coupled to the data compressor logic and configured to generate the data stream.

8. The apparatus as recited in claim 5, further comprising a facsimile engine that is operatively coupled to the data compressor logic and configured to generate the data stream.

9. The apparatus as recited in claim 5, further comprising a data port that is operatively coupled to the data compressor logic and configured to provide the data stream.

10. A method comprising:
counting consecutive alike n-bit long words in a data set; and
for each grouping of consecutive alike n-bit long words in the data set, substituting a control word that identifies a value of the alike n-bit long words and a counted number of alike n-bit long words within the grouping.

11. The method as recited in claim 10, where in the data set is associated with a scanned image and the alike n-bit long words are selected from a grouping of image pattern values associated with white regions, black regions, and repeating pattern regions.

12. The method as recited in claim 10, further comprising converting a data bitstream into n-bit long words to produce the data set.

13. The method as recited in claim 10, further comprising generating a compressed data stream comprising at least one control word.

14. The method as recited in claim 13, wherein substituting a control word that identifies a value of the alike n-bit long words and a counted number of alike n-bit long words within the grouping further includes providing at least one identifier control word in the compressed data stream that specifically identifies data words and control words therein.

15. A computer-readable medium having computer-executable instructions for performing steps comprising:
counting consecutive alike n-bit long words in a data set; and
for each grouping of consecutive alike n-bit long words in the data set, substituting a control word that identifies a value of the alike n-bit long words and a counted number of alike n-bit long words within the grouping.

16. The computer-readable medium as recited in claim 15, wherein the data set is associated with a scanned image and the alike n-bit long words are selected from a grouping of image pattern values associated with white regions, black regions, and repeating pattern regions.

17. The computer-readable medium as recited in claim 15, further comprising computer-executable instructions for converting a data bitstream into n-bit long words to produce the data set.

18. The computer-readable medium as recited in claim 15, further comprising computer-executable instructions for generating a compressed data stream comprising at least one control word.

19. The computer-readable medium as recited in claim 18, wherein substituting a control word that identifies a value of the alike n-bit long words and a counted number of alike n-bit long words within the grouping further includes computer-executable instructions for providing at least one identifier control word in the compressed data stream that specifically identifies data words and control words therein.

20. A binary signal comprising at least one control word that is n-bits long, wherein the control word identifies a value of alike n-bit long data words and a counted number of the alike n-bit long words within a grouping thereof.
